(19) United States
(12) Patent Application Publication
(10) Pub. No.: US 2025/0317719 A1
(43) Pub. Date: Oct. 9, 2025

(54) METHOD FOR CHECKING THE PLAUSIBILITY OF DATA OF AN EXTERNAL ENVIRONMENTAL SENSOR SYSTEM BY AT LEAST ONE NETWORKED ROAD USER, NETWORKED MOTOR VEHICLE AND INFRASTRUCTURE SYSTEM

(71) Applicant: Robert Bosch GmbH, Stuttgart (DE)

(72) Inventors: Heiko Freienstein, Weil Der Stadt (DE); Johannes Christian Mueller, Stuttgart (DE); Peter Schneider, Holzgerlingen (DE)

(21) Appl. No.: 19/079,554

(22) Filed: Mar. 14, 2025

(30) Foreign Application Priority Data
Apr. 9, 2024 (DE) 10 2024 203 221.2

(51) Int. Cl. H04W 4/44; H04L 67/12; H04W 4/38

(52) U.S. Cl. CPC H04W 4/44; H04L 67/12; H04W 4/38

(57) ABSTRACT

A method for checking the plausibility of data of an external environmental sensor system by at least one networked road user. Data of an external data source are received using a communication system of the networked road user. The data include first environmental information, acquired by an external environmental sensor system assigned to the external data source, which represents a first spatial area. The networked road user includes an internal environmental sensor system, having a safe sensor range. Second environmental information is generated using the internal environmental sensor system of the networked road user, wherein the second environmental information originates from a sub-area of the first spatial area. The data of the external environmental sensor system are checked for plausibility depending on the first environmental information and the second environmental information.

### CROSS REFERENCE

The present application claims the benefit under 35 U.S.C. § 119 of German Patent Application No. DE 10 2024 203 221.2 filed on Apr. 9, 2024, which is expressly incorporated herein by reference in its entirety.

### FIELD

The present invention relates to a method for checking the plausibility of data of an external environmental sensor system by at least one networked road user. The present invention furthermore relates to a networked, in particular at least partially automated, motor vehicle. The present invention furthermore relates to an infrastructure system designed in particular for driving assistance of at least partially automated, networked motor vehicles.

### BACKGROUND INFORMATION

As in other fields of technology, networking is playing an increasingly important role in vehicle applications. More and more vehicles have the possibility of connecting within a cloud to other road users, to infrastructure components (e.g., so-called roadside units) or to backend services. In order to ensure the safety of such networked road users, it is important to check the transferred data for plausibility. In particular, the transmitted data can comprise information about an environment of the road user, wherein in particular information about objects and their properties (features) are transmitted.

Germany Patent Application No. DE 10 2019 213 929 A1 describes a plausibility check of formerly dynamic objects that have come to a stop. A device provided for this purpose comprises a plausibility check unit that performs the plausibility check of a dynamic object recognized by a dynamic environment perception unit, by means of information about a static object recognized by a static environment perception unit, and/or vice versa.

Europe Patent No. EP 0 815 547 B2 describes a method for ascertaining dynamic traffic information. For this purpose, a control center takes over the communication management of various end devices (road users, infrastructure), prepares the data and assigns them to route sections in a database. Here, the plausibility check and a comparison are performed by means of the traffic flow information obtained via road-side infrastructure systems.

Many environmental sensors used in such methods or systems have a maximum range or conditions within which they function according to specification and provide good-quality measurements, which are aggregated into object lists, for example. Beyond this range, typical features and thus also evaluation algorithms fall away. Although certain signal features of the measurement signal of an environmental sensor are retained even at large distances or in the case of very difficult non-line-of-sight scenarios (measurements around corners, more specifically measurement signals received via an indirect path), they generally can no longer be used meaningfully and are therefore discarded.

### SUMMARY

An object of the present invention is to provide a reliable method for checking the plausibility of data of an external environmental sensor system.

A further object of the present invention is to provide a highly reliable infrastructure system for driving assistance of at least partially automated, networked motor vehicles.

According to a first aspect of the present invention, a method for checking the plausibility of data of an external environmental sensor system by at least one networked road user is proposed. The networked road user may, for example, be a networked motor vehicle, in particular an at least partially automated, networked motor vehicle. The method according to the present invention comprises at least the following steps:

Data of an external data source are received by means of a communication system of the networked road user.

The data comprise first environmental information acquired by an external environmental sensor system assigned to the external data source. Here, the first environmental information represents a first spatial area and, in particular, comprises first features of one or more objects within this first spatial area. A typical external environmental sensor system may comprise, for example, one or more camera systems and/or one or more radar sensors and/or lidar sensors. The features of the object, which are preferably determined from the measurement data acquired by means of the environmental sensor system, comprise, for example, a position and/or a distance and/or a velocity (direction and/or magnitude) and/or dimensions and/or an object type (e.g., pedestrian, bicycle, passenger car, . . . ) of the object. Features of multiple, different objects may also be comprised, and the data may, for example, comprise them in the form of an object list. For example, the environmental sensor system may comprise a stationary environmental sensor system that, for example, is fixedly installed on a road infrastructure and monitors the area of the roadway.

The networked road user comprises an internal environmental sensor system. This internal environmental sensor system has a safe sensor range, wherein the safe sensor range is defined such that the internal environmental sensor system can safely detect objects within the safe sensor range. The safe sensor range is also defined such that the internal environmental sensor system cannot safely detect objects outside the safe sensor range. A “safe” or “non-safe” detection means in particular an acquisition of object properties with an accuracy and reliability that is sufficient to ensure safe operation of the networked road user. In particular, a collision probability, derived from the object properties, of an object with the networked road user can be determined with high reliability within the thus defined “safe sensor range.” Alternatively or additionally, the “safe sensor range” may be determined by the specifications of the environmental sensor used. The sensor technology used by the internal environmental sensor system may, for example, be the reason that safe detection of object properties is not possible for objects outside the safe sensor range. For example, outside their specified range, radar sensors do not allow unambiguous determination of an object position or object velocity.

The first spatial area, which is monitored by the external environmental sensor system, is outside the safe sensor range.

According to an example embodiment of the present invention, it is provided that second environmental information is generated by means of the internal environmental sensor system of the networked road user, wherein the second environmental information originates from a sub-area of the first spatial area and, in particular, comprises second features of the object or the multiple objects in the sub-area. The data of the external environmental sensor system are checked for plausibility depending on the first environmental information and the second environmental information, in particular depending on a comparison of the first features and the second features.

The present invention is thus based on the idea that even environmental information (the first environmental information) originating from an area outside a safe sensor range of the internal environmental sensor system of the networked road user can be used to check the plausibility of the data of the external environmental sensor system. A plausibility check of the data of the external environmental sensor system is thus carried out on the basis of signals that would otherwise have to be discarded due to a lack of or ambiguous features for the ‘normal’ specified purposes (e.g., object detection and tracking).

Accordingly, the present invention makes it possible to check the plausibility of a, for example remote, external environmental sensor system (e.g., infrastructure sensor system) by means of another, internal sensor system (e.g., a vehicle-based on-board sensor system) on the basis of features that would be used only marginally for normal object detection or would be discarded: That is to say, to check the plausibility of a remote, external environmental sensor system when there are no overlap ranges with the established detection range of the internal environmental sensor system.

In particular, the proposed method of the present invention is not a sensor data fusion, in which the uncertainties of a measurement would be reduced by a combination of sensor data (so-called multi-sensor fusion) or in which the decisions of individual classifiers would be combined into a single decision (so-called decision fusion). The proposed approach according to the present invention, on the other hand, determines an independent plausibility of external sensor information by incorporating the measurement data, or information derived therefrom, from an area beyond the safe sensor range and can evaluate this external sensor information with regard to a specific maneuver.

In a preferred embodiment of the present invention, the plausibility check of the data of the external environmental sensor system is carried out by means of a combination of a redundancy-based check and a model-based check of the first environmental information, taking into account the second environmental information. The terms “model-based check” and “redundancy-based check” are used here in particular within the framework of their definition and description in Versmold and Saeger (Versmold, H, Saeger, M, “Plausibility Checking of Sensor Signals for Vehicle Dynamics Control Systems,” Forschungsgesellschaft Kraftfahrwesen Aachen [Automotive Engineering Research Company of Aachen], 2006). A redundancy-based check is understood to mean a comparison of object representations of the external environmental sensor system and of the internal environmental sensor system. Since the second environmental information does not provide reliable object representation due to the above-discussed problems of the limited sensor range, a model-based check is additionally carried out. The model-based check uses additional, available information about the first spatial area and/or sensor-specific information of the internal environmental sensor system. Additional information that cannot be taken from the sensor signals or environmental information itself but is provided, for example, by a further source or an existing environmental model is used. Here, for example, known information about the first spatial area, such as a design and layout of the road, a course of a lane, occlusions of certain sections, light signal systems, or map data, can be used. Furthermore, sensor-specific information, such as the sensor type, known signal characteristics under certain conditions, . . . can be used in the model-based check. Through the combination of a redundancy-based check and a model-based check, an improved plausibility check of the data of the external environmental sensor system can be implemented.

In a particularly preferred example embodiment of the present invention, a relationship between the first features and the second features is defined for the model-based check, in particular by means of an algorithm, at least as a function of the sensor modality of the internal environmental sensor system and available further information about the first spatial area, in particular a digital map.

In a particularly preferred example embodiment of the present invention, the plausibility check may be carried out in accordance with a specified set of rules (rule book), wherein the set of rules comprises a description of the conditions that the first features must satisfy depending on the second features for an assessment as plausible, and/or wherein the set of rules comprises a description of the conditions for the first and second features that result in an assessment as implausible.

The set of rules can in particular be present as a data structure on the side of the networked road user (receiver side). It comprises, for example, both the possible first features (from the external data source) that are to be checked for plausibility and possible second features (acquired by the internal environmental sensor system). In particular, the set of rules furthermore comprises a description of the conditions that can result in an assessment as plausible. The set of rules may also comprise a description of the conditions that can result in an assessment as implausible.

In one possible embodiment of the present invention, the set of rules comprises:
a first list of potential first features that the external environmental sensor system has measured and the external data source has transmitted,
a second list of potential second features that can be generated by the internal environmental sensor system and that can be used to assess plausibility
   the second list contains information from measurements (measured signals) as features
   the second list contains provided information (e.g., map-based information or model assumptions) as additional features
calculation rules of the plausibility criteria and of the parameters of these rules applicable to elements of the first list by incorporating one or more features from the second list.

One possible embodiment example of a form of implementation of such a set of rules is a logic gate and truth tables stored in the set of rules. The set of rules can thus be implemented particularly easily.

In a further preferred embodiment of the present invention, an assumption for a traffic scenario is alternatively or additionally generated by means of the first environmental information. A plausibility check of the data of the external environmental sensor system can now be carried out by checking whether the second environmental information confirms or refutes the assumption. For example, based on the objects acquired by the external environmental sensor system and their properties (first features), a most likely traffic scenario can be selected from a specified list of scenarios (e.g., a turn situation, crossing of a pedestrian or an emergency vehicle, . . . ). Subsequently, it can be checked whether the second environmental information or the second features support the selected traffic scenario. This is usually possible even if the second features do not allow for unambiguous characterization of an object.

Thus, in a preferred embodiment of the present invention, the plausibility check can be carried out depending on whether properties, determined by means of the first and the second environmental information, in particular distances and/or positions and/or velocity components, of an object within the sub-area match. For example, it is possible that the second environmental information only comprises partial signals from which a complete set of object properties cannot be determined, but certain properties such as one or more velocity components of the object and/or an object distance can. These partial signals can be used for the plausibility check.

In a preferred embodiment of the present invention, a level of plausibility can be ascertained as a result of the plausibility check of data of an external environmental sensor system, and the data of the external data source can be classified as plausible depending on the level of plausibility. This has the advantage that the available assessment is not purely binary (plausible or implausible), but rather a grading can be carried out depending on the first environmental information and the second environmental information or depending on a comparison of the first features and the second features, and various measures can be provided, for example, depending on the level of plausibility.

In the context of the present invention, the external data source and/or the external environmental sensor system can be designed as part of a networked motor vehicle or as part of an infrastructure system.

In the context of the present invention, the networked road user can be designed as a networked motor vehicle or as an infrastructure system.

In a preferred embodiment of the present invention, the networked road user is designed as an at least partially automated, networked motor vehicle, wherein at least one at least partially automated, in particular highly automated, driving function of the motor vehicle is controlled depending on the plausibility-checked data of the external environmental sensor system. In particular, critical driving maneuvers can be enabled depending on the plausibility check. This improves the safety of the partially automated, in particular highly automated, driving function of the motor vehicle, for example by disabling or restricting the function if there is no or poor plausibility of the data of the external environmental sensor system.

According to a second aspect of the present invention, a networked, in particular at least partially automated, motor vehicle is designed to carry out a method according to the first aspect of the present invention. According to an example embodiment of the present invention, the motor vehicle comprises:
a communication system designed to receive data comprising first environmental information of an external data source, wherein the first environmental information data have been acquired by an external environmental sensor system of the external data source, and wherein the first environmental information represents a first spatial area and, in particular, describes one or more objects.
an internal environmental sensor system designed to generate second environmental information, wherein the second environmental information originates from a sub-area of the first spatial area and represents features of one or more objects in the sub-area. The internal environmental sensor system has a safe sensor range, wherein the safe sensor range is defined such that the internal environmental sensor system can safely detect objects within the safe sensor range and that the internal environmental sensor system cannot safely detect objects outside the safe sensor range, wherein the first spatial area is outside the safe sensor range.
a plausibility check module designed to perform a plausibility check of the data of the external environmental sensor system depending on the first environmental information and the second environmental information.

In a preferred embodiment of the present invention, the internal environmental sensor system of the networked, in particular at least partially automated, motor vehicle comprises a radar sensor and/or a video sensor and/or a lidar sensor.

According to a third aspect of the present invention, an infrastructure system is provided. According to an example embodiment of the present invention, the infrastructure system comprises:
an environmental sensor system designed to generate first environmental information, wherein the first environmental information originates from a sub-area of a first spatial area and characterizes at least one object within the spatial area,
a communication system designed to transmit data comprising the first environmental information to a networked road user such that
the road user can carry out a method according to the first aspect for checking the plausibility of the data, wherein the infrastructure system comprises the external data source.

In a preferred embodiment of the infrastructure system of the present invention, the environmental sensor system comprises a stationary sensor system comprising at least one camera and/or one lidar sensor and/or one radar sensor.

The term “networked motor vehicle” includes a motor vehicle that comprises a suitable communication device with which the networked motor vehicle can exchange data with other road users, in particular with an infrastructure system. For this purpose, a wireless data connection via which the networked motor vehicle can transmit and/or receive data is established. This can preferably be a radio link, for example a mobile radio link or a direct wireless connection. Such communication between a motor vehicle and another road user is also referred to as V2X or C2X communication.

The term “at least partially automated” includes one or more of the following cases: assisted driving, partially automated driving, highly automated driving, and fully automated driving of a motor vehicle.

Assisted driving means that a driver of the motor vehicle continuously carries out either the lateral guidance or the longitudinal guidance of the motor vehicle. The respectively other driving task (i.e., controlling the longitudinal guidance or the lateral guidance of the motor vehicle) is carried out automatically. This means that either the lateral guidance or the longitudinal guidance is controlled automatically when the motor vehicle is driven in an assisted manner.

Partly automated guidance means that, in a specific situation (for example: driving on a freeway, driving in a parking lot, passing an object, driving within a lane defined by lane markings) and/or for a certain period of time, a longitudinal guidance and a lateral guidance of the motor vehicle are controlled automatically. A driver of the motor vehicle does not have to manually control the longitudinal and lateral guidance of the motor vehicle. However, the driver must continuously monitor the automatic control of the longitudinal and lateral guidance in order to be able to intervene manually when necessary. The driver must be ready at all times to fully take over motor vehicle guidance.

Highly automated guidance means that, for a certain period of time in a specific situation (for example: driving on a freeway, driving in a parking lot, passing an object, driving within a lane defined by lane markings), a longitudinal guidance and a lateral guidance of the motor vehicle are controlled automatically. A driver of the motor vehicle does not have to manually control the longitudinal and lateral guidance of the motor vehicle. The driver does not have to continuously monitor the automatic control of the longitudinal and lateral guidance in order to be able to intervene manually when necessary. When necessary, a take-over request to take over control of the longitudinal and lateral guidance is automatically issued, in particular issued with a sufficient time reserve, to the driver. The driver thus has to potentially be able to take control of the longitudinal and lateral guidance. Limits of the automatic control of the lateral and longitudinal guidance are recognized automatically. In highly automated driving, it is not possible to bring about a minimal risk state in every initial situation automatically.

Fully automated guidance means that, in a specific situation (for example: driving on a freeway, driving in a parking lot, passing an object, driving within a lane defined by lane markings), a longitudinal guidance and a lateral guidance of the motor vehicle are controlled automatically. A driver of the motor vehicle does not have to manually control the longitudinal and lateral guidance of the motor vehicle. The driver does not have to monitor the automatic control of the longitudinal and lateral guidance in order to be able to intervene manually when necessary. Before the automatic control of the lateral and longitudinal guidance is ended, the driver is automatically requested to take over the driving task (control of the lateral and longitudinal guidance of the motor vehicle), in particular with a sufficient time reserve. If the driver does not take over the driving task, a return to a minimal risk state takes place automatically. Limits of the automatic control of the lateral and longitudinal guidance are recognized automatically. In all situations, it is possible to return to a minimal risk system state automatically.

Driverless control or driving means that, regardless of a specific situation (for example: driving on a freeway, driving in a parking lot, passing an object, driving within a travel lane defined by lane markings), a longitudinal guidance and a lateral guidance of the motor vehicle are controlled automatically. A driver of the motor vehicle does not have to manually control the longitudinal and lateral guidance of the motor vehicle. The driver does not have to monitor the automatic control of the longitudinal and lateral guidance in order to be able to intervene manually when necessary. The longitudinal and lateral guidance of the vehicle is thus controlled automatically, for example for all road types, velocity ranges and environmental conditions. The entire driving task of the driver is thus taken over automatically. The driver is therefore no longer required. The motor vehicle can thus drive from any starting position to any destination position even without a driver. Potential problems are solved automatically, i.e., without the help of the driver.

Remote control of the motor vehicle means that a lateral and longitudinal guidance of the motor vehicle is controlled remotely. This means, for instance, that remote control signals for remotely controlling the lateral and longitudinal guidance are transmitted to the motor vehicle. The remote control is carried out by a remote control device, for example.

### BRIEF DESCRIPTION OF THE DRAWINGS

Embodiments of the present invention are described in detail with reference to the accompanying figures.

FIGS. 1A and 1B show a data source and a networked motor vehicle for illustrating a method for checking the plausibility of data of an external environmental sensor system according to a first embodiment example of the present invention.

FIG. 2 shows a block diagram of a method for checking the plausibility of data of an external environmental sensor system according to a second embodiment example of the present invention.

FIGS. 3A-3C show various second environmental information and its interpretation according to a possible embodiment of the present invention.

FIGS. 4A and 4B show two spaced-apart infrastructure systems, each acting as an external data source and networked road user, in a method for checking the plausibility of data of an external environmental sensor system according to a further embodiment example of the present invention.

### DETAILED DESCRIPTION OF EXAMPLE EMBODIMENTS

In the following description of the embodiment examples of the present invention, the same elements are denoted by the same reference signs and a repeated description of these elements is omitted where appropriate. The figures show the subject matter of the present invention only schematically.

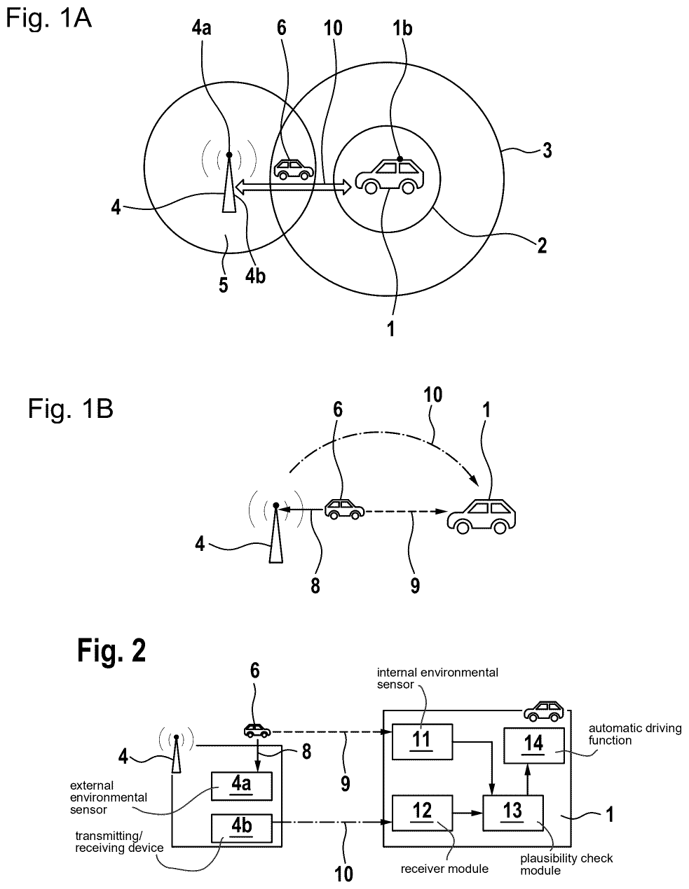

FIG. 1A shows a possible starting situation for a method according to the present invention. A networked motor vehicle 1 moves at a certain distance from an infrastructure system 4. The infrastructure system comprises an external environmental sensor system 4a and a transmitting/receiving device 4b. A communication link 10 via which data are transmitted to the networked motor vehicle 1, for example by means of V2X, exists between the networked motor vehicle 1 and the infrastructure system 4, wherein the data comprise first environmental information acquired by the external environmental sensor system 4a. This first environmental information represents a first spatial area 5 corresponding to a sensor range of the external environmental sensor system 4a and comprises first features of an object 6, here a further motor vehicle, within the first spatial area 5.

The networked motor vehicle 1 comprises an internal environmental sensor system 1b, which has a safe sensor range 2 (detection range of the established evaluation). The object 6 is located in an area 3 that is outside the safe sensor range 2 but from which the internal environmental sensor system can still receive sensor signals, which however would not be used or would be used only marginally for normal object detection.

The present invention now provides an approach for how these sensor signals from outside the safe sensor range 2 can still be used for checking the plausibility of the data of the external environmental sensor system 4a.

This is shown schematically in FIG. 1B. The external environmental sensor system 4a acquires the object 6, and first features 8 of the object are generated as the first environmental information. This first environmental information or these first features are transmitted to the networked motor vehicle 1 via a communication link 10. At the same time, an internal environmental sensor system of the networked motor vehicle 1 acquires sensor signals 9 representing the object 6. This results in second environmental information or second features 9 of the object 6. Since the object 6 is outside a safe sensor range 2 of the networked motor vehicle 1, the second environmental information or second features 9 alone cannot provide reliable information. However, the second environmental information or second features 9 can be used according to the present invention to check the plausibility of the first features 8 and thus of the data of an external environmental sensor system 4a.

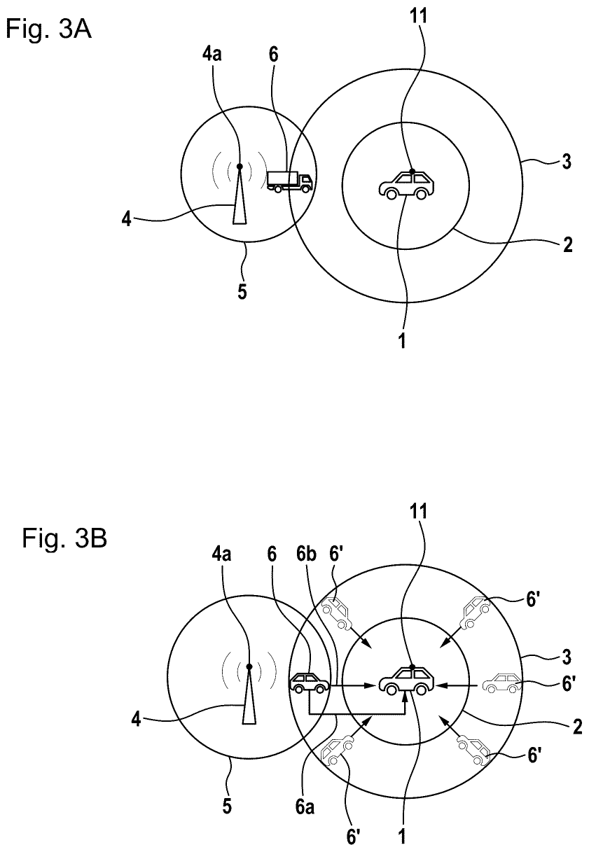

An example of an implementation of a method according to the present invention is shown in FIG. 2 as a block diagram. Block 4 represents the external data source, for example an infrastructure system. The external data source comprises an external environmental sensor system 4a. First features 8 of an object 6 can be determined by means of the environmental sensor system 4a. The first features 8 and, where appropriate, further data can be transmitted by means of a communication link 10 (e.g., V2X) from the data source 4 to a networked road user 1, in this example a networked, automated motor vehicle.

The networked road user 1 comprises a receiver module 12 designed to receive the data of the external data source. The networked road user 1 also comprises an internal environmental sensor system 11. The internal environmental sensor system 11 is capable of acquiring second features 9 of the object 6. However, the object 6 is outside the specified safe sensor range of the internal environmental sensor system 11 so that the second features 9 alone are not sufficient to characterize the object 6 in a manner sufficient for the safe implementation of an automated driving function. For example, the features 9 do not represent an unambiguous position or velocity of the object 6.

According to the present invention, the second features 9 can still be used to check the plausibility of the first features 8 received from the external data source 4. For this purpose, the networked road user 1 comprises a plausibility check module 13, which can calculate a plausibility level for the first features 8, taking into account the second features 9. In particular, a data fusion of the first features 8 and the second features 9 is not performed. Instead, for example, it can be checked whether a traffic scenario determined based on the first features 8 is supported by the second features 9. Depending on the result of the plausibility check, an automatic driving function 14 of the networked road user 1, which is designed as an automated motor vehicle in this example, can be controlled or regulated. For example, depending on the result of the plausibility check, safety-critical driving maneuvers may or may not be enabled.

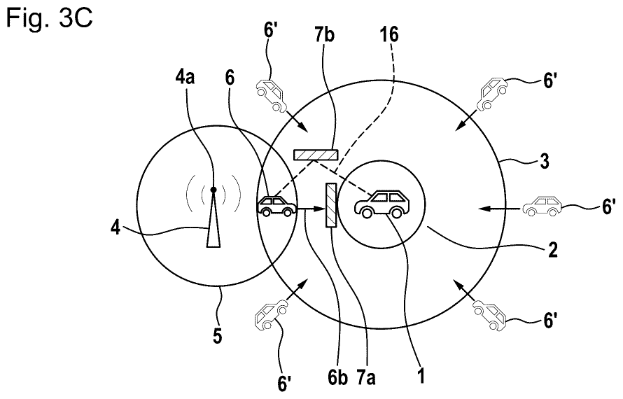

Various embodiment examples of the present invention are shown in FIGS. 3A-3C. In each case, an infrastructure system as an external data source 4 with a video sensor system as an external environmental sensor system 4a is shown. A networked motor vehicle is shown as a networked road user 1. The networked motor vehicle comprises a radar sensor as an internal environmental sensor system 11.

The video sensor system of the infrastructure system monitors a range 5, and the radar sensor monitors a range 2. These ranges are disjoint so that a logic in the motor vehicle has no way of checking the plausibility of the measurement of the environmental sensor system 4a by comparisons with its own measurements. However, the radar sensor system of the motor vehicle can perceive targets (objects) 6 outside the range 2.

In FIG. 3A, this is shown using the example of measurements of certain targets with large scattering cross-sections, here using the example of a truck, over large distances. Unambiguous object features can be determined here despite the large distance since the received radar signals reflected from the large object or the object with the large scattering cross-section contain enough information. A direct comparison of the location and velocity vector of the truck determined by the sensor systems 4a and 11 can be performed. From the comparison, conclusions can be drawn about the principal functionality of the infrastructure sensor system 4a.

FIG. 3B shows a situation in which an elevation measurement or angle measurement is no longer possible due to the distance between the internal environmental sensor system 11 and the object 6. However, the distance 6a between the object 6 and the motor vehicle, as well as the relative velocity 6b, can be measured unambiguously. This therefore results in an ambiguity in the absolute position of the object 6 (indicated by some “virtual objects” 6′ matching the ambiguity), but the available features can still be used for the plausibility check of the data of the external environmental sensor system 4a.

FIG. 3C shows a situation in which the direct signal path between the object 6 and the internal environmental sensor system 11 is blocked due to an obstacle 7a. A radar signal 16 can still reach the sensor via multiple reflection, e.g., on a further object 7b. In this case, even the distance between the object 6 and the motor vehicle can no longer be determined unambiguously, only the relative velocity 6b can.

In the situations shown in FIGS. 3B and 3C, the state (location vector and velocity vector) of the object 6 cannot be compared, since the positions and velocities determined by the radar sensor of the motor vehicle are not unambiguous, but there is the possibility of a plausibility check. In these examples, two scalar variables are acquired in each case, namely the radial speed |v_rad| 6b and the distance 6a. For the plausibility check, the question of whether the measurement values provided by the infrastructure match the signature in the R-v space can now be clarified. The R-v space can be understood to mean a state space in which measurements of objects can be assessed on the basis of their relative distance (radius R) and their relative velocity (velocity v). Alternatively or additionally, a probability of a true measurement may be determined if an independent trustworthy measurement of meaningful features is available. In this way, for example, the acceptance of false-positive measurements can be significantly reduced (an approach via conditional probabilities in order to calculate the improvement can be calculated, for example, analogously to Heinrich Ruser, “Ultraschall-Mikrowellen-Sensorsystem zur Geschwindigkeits-und Abstandsmessung mit diversitär-redundanter Auswertung der Phasensignale [Ultrasonic-microwave sensor system for velocity and distance measurement with a diversity-redundant evaluation of the phase signals], University of the Bundeswehr, Munich 2003”).

The more concise the measurement in the R-v space is, the higher the level of plausibility can be. A concise measurement is to be understood as a measurement that can be interpreted well, i.e., that is distinctly pronounced and stronger than any interferences and measurement artifacts and can be delineated from signals of other objects (e.g., can be separated from the ground measurement values or the measurement values of neighboring objects). Further information, e.g., map information, can also be incorporated. It is advantageous for the plausibility check, for example, if map information can be used to conclude that the ascertained v-R profile can most likely be driven exclusively on the road observed by the infrastructure. If this profile matches the current observation, plausibility can be checked successfully.

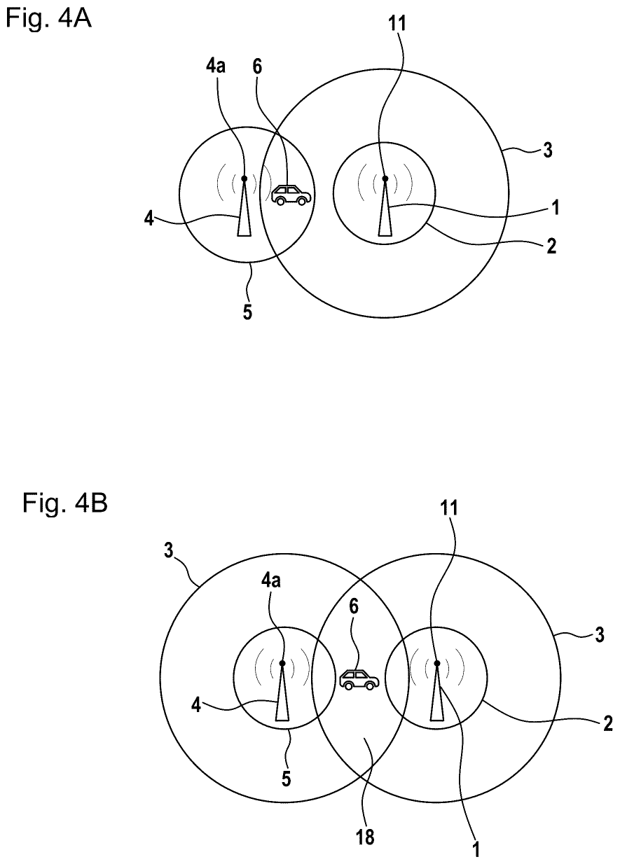

FIG. 4A shows that the principle of the present invention can also be applied between two infrastructure systems 1, 4 that are remote from one another. In this case, the second infrastructure system plays the role of the networked road user.

FIG. 4B shows two infrastructure systems 1, 4 in which the object 6 to be tracked is outside the safe sensor ranges 2 and 5 of the two infrastructure systems 1, 4 of the two environmental sensor systems 4a and 11. By continuously tracking and applying the principles of the present invention, the object can still be observed continuously, in particular also in the overlap range 18. This situation in particular represents a transition of the object 6 from the range 5 to the range 2. The object 6 is first clearly tracked in the range 2 by the infrastructure system 1 and then moves outside the safe sensor ranges 2 and 5 of the two infrastructure systems 1, 4. It is still perceived by both infrastructure systems 1, 4, even though the signals originate from outside the safe sensor ranges 2 and 5 of the infrastructure systems 1, 4. Under the condition that tracking has not been interrupted, these signals may also be sufficient to check the plausibility of the existence of the object 6.

For all of the aforementioned embodiments, a direct approach can be taken for checking the plausibility of a message, containing information on relevant objects 6, from an infrastructure system as an external data source 4:

An object acquired by the external environmental sensor system 4a is assessed as plausible or implausible by means of measurement signals received by the internal environmental sensor 11 of the networked road user 1.

The way in which the thus obtained information about the plausibility is further used can in particular depend on the driving task of the networked road user. The following examples are to illustrate this:
A driving maneuver, such as a starting maneuver before a crossing, which, in terms of safety criticality, depends on whether an object 6 approaches from one side, should assume an approaching vehicle or object even if plausibility is not given.
A driving maneuver, such as traversing a crossing, which requires a time gap of a minimum duration, for example, can be performed if the plausibility of the data of the object 6 provided by the external data source 4 is given.
A driving maneuver, such as traversing a crossing, which requires a time gap of a minimum duration, for example, can be terminated if the plausibility of the data of the object 6 provided by the external data source 4 is not given.
In the case of an NCAP-ADAS function, such as automatic emergency braking to avoid collisions, a V2X message (e.g., a collective perception message) that is received by the networked road user 1 and that would trigger an emergency braking maneuver due to the environmental information contained therein can first be subjected in the networked vehicle to a plausibility check by means of locally measured environmental information. Only if this plausibility check is successful will the emergency braking actually be carried out.

Analogously to the examples described above, a plausibility check of data transmitted between two vehicles can also be performed.

If the data received from the external data source do not contain any environmental information on relevant objects (for a specific driving maneuver), the procedure can be as follows.

This case may be more challenging to handle since the plausibility/implausibility of the data without objects on the basis of the signals acquired by the internal environmental sensor system is not trivial. Simply checking for contradiction is in many cases not sufficient here, since the signals acquired by the internal environmental sensor system and originating from outside the safe (specified) sensor range are to be assumed to be non-specific and it thus must be expected that, too often, a simple concept cannot provide plausibility due to artifacts (e.g., as a result of so-called radar clutter) or due to remote, irrelevant objects. In this case, the signals acquired by the internal environmental sensor system can be filtered strictly in order to avoid false detections and thus increase the validity.

For example, this “strict” filtering may comprise two filter stages:

In a first filter stage 1, the signals are compared with all observed objects and are checked to determine whether they are easily explained. The signals that have not been explained remain.

In a second filter stage, the road geometry and the knowledge about the maximum possible and relevant velocity are used as limits for a capture range in the specific situation. This may be a range in the R-v space (e.g., a distance interval [R1, R2] and a velocity interval [v1, v2]). Only signals in this range are used to disprove the plausibility of the message. If there are no signals in this range, the message is assessed to be plausible. However, if there are signals in this range, the message is implausible. In this case, it must be assumed that there may be relevant objects.

Ultimately, even in these cases, the use of the information depends on the plausibility and the driving task. The following example is to illustrate this:

A driving maneuver, such as a starting maneuver before a crossing, which depends on whether someone in principle approaches from one side, should assume an approaching vehicle as an object 6 even if a message contains no relevant objects 6 and if plausibility is not given. In this case, although the external environmental sensor system 4a did not see any object, the maneuver driven is a more cautious maneuver that does not create a conflict with the potentially approaching vehicle (object) 6 or at most results in a potential situation in which, assuming normal cooperative reactions, there is no dangerous conflict.

In all of the exemplary scenarios or driving tasks or embodiment examples mentioned, the method according to the present invention advantageously prevents or makes it significantly more difficult, for example,
that incorrectly generated V2X signals from possibly non-intrinsically safe infrastructure components lead to a potentially hazardous vehicle behavior
   and
that malicious attackers (in the sense of security) can abuse a V2X interface with little effort for unwanted influence (and possibly even dangerous influence) of the vehicle behavior.

What is claimed is:

1. A method for checking plausibility of data of an external environmental sensor system by at least one networked road user, the method comprising the following steps:
receiving data of an external data source using a communication system of the networked road user, wherein the data include first environmental information acquired by an external environmental sensor system of the external data source, and wherein the first environmental information represents a first spatial area and includes first features of an object within the first spatial area, wherein the networked road user includes an internal environmental sensor system, and wherein the internal environmental sensor system has a safe sensor range, wherein the safe sensor range is defined such that the internal environmental sensor system can safely detect objects within the safe sensor range and that the internal environmental sensor system cannot safely detect objects outside the safe sensor range, wherein the first spatial area is outside the safe sensor range;
generating second environmental information using the internal environmental sensor system of the networked road user, wherein the second environmental information originates from a sub-area of the first spatial area and includes second features of the object in the sub-area;
performing a plausibility check of the data of the external environmental sensor system depending on the first environmental information and the second environmental information, including depending on a comparison of the first features and the second features.

2. The method according to claim 1, wherein the plausibility check of the data of the external environmental sensor system is performed using a combination of a redundancy-based check and a model-based check of the first environmental information, taking into account the second environmental information, wherein available information about the first spatial area and/or sensor-specific information of the internal environmental sensor system is used for the model-based check.

3. The method according to claim 2, wherein a relationship between the first features and the second features is defined for the model-based check using an algorithm, at least as a function of a sensor modality of the internal environmental sensor system and available further information about the first spatial area including a digital map.

4. The method according to claim 2, wherein the plausibility check is carried out in accordance with a specified set of rules, wherein: (i) the set of rules includes a description of conditions that the first features must satisfy depending on the second features for an assessment as plausible, and/or (ii) the set of rules includes a description of conditions for the first features and second features that result in an assessment as implausible.

5. The method according to claim 4, wherein the set of rules comprises at least one truth table and/or one logic gate.

6. The method according to claim 1, wherein an assumption for a traffic scenario is generated using the first environmental information, a plausibility check of the data of the external environmental sensor system being carried out by checking whether the second environmental information confirms or refutes the assumption.

7. The method according to claim 1, wherein the plausibility check can be carried out depending on whether properties, determined using the first and the second environmental information, including distances and/or positions and/or velocity components, of an object within the sub-area match.

8. The method according to claim 1, wherein the second environmental information includes partial signals, including one or more velocity components of the object and/or an object distance.

9. The method according to claim 1, wherein a level of plausibility is ascertained and the environmental information of the external data source is classified as plausible depending on the level of plausibility.

10. The method according to claim 1, wherein the external data source and/or the external environmental sensor system is part of a networked motor vehicle or part of an infrastructure system.

11. The method according to claim 1, wherein the networked road user is a networked motor vehicle or an infrastructure system.

12. The method according to claim 1, wherein the networked road user an at least partially automated, networked motor vehicle, and wherein at least one at least partially automated driving function of the motor vehicle is controlled depending on the plausibility-checked environmental information of the external environmental sensor system, wherein critical driving maneuvers are enabled depending on the plausibility check.

13. A networked, at least partially automated, motor vehicle, comprising:
a communication system configured to receive data including first environmental information of an external data source, wherein the first environmental information data have been acquired by an external environmental sensor system of the external data source, and wherein the first environmental information represents a first spatial area and describes an object;
an internal environmental sensor system configured to generate second environmental information, wherein the second environmental information originates from a sub-area of the first spatial area and represents features of an object in the sub-area, wherein the internal environmental sensor system has a safe sensor range, and wherein the safe sensor range is defined such that the internal environmental sensor system can safely detect objects within the safe sensor range and that the internal environmental sensor system cannot safely detect objects outside the safe sensor range, wherein the first spatial area is outside the safe sensor range; and
a plausibility check module configured to perform a plausibility check of the environmental information of the external environmental sensor system depending on the first environmental information and the second environmental information.

14. The networked motor vehicle according to claim 13, wherein the internal environmental sensor system includes a radar sensor and/or a video sensor and/or a lidar sensor.

15. An infrastructure system for driving assistance of at least partially automated, networked motor vehicles, comprising:
an environmental sensor system configured to generate first environmental information, wherein the first environmental information originates from a sub-area of a first spatial area and characterizes at least one object within the spatial area;
a communication system configured to transmit data including the first environmental information to a networked road user;
wherein the networked road user can carry out a method for checking plausibility of data of the environmental sensor system, the method including:
receiving data of an external data source using a communication system of the networked road user, wherein the data include the first environmental information acquired by an external environmental sensor system of the external data source, wherein the networked road user includes an internal environmental sensor system, and wherein the internal environmental sensor system has a safe sensor range, wherein the safe sensor range is defined such that the internal environmental sensor system can safely detect objects within the safe sensor range and that the internal environmental sensor system cannot safely detect objects outside the safe sensor range, wherein the first spatial area is outside the safe sensor range,
generating second environmental information using the internal environmental sensor system of the networked road user, wherein the second environmental information originates from a sub-area of the first spatial area and includes second features of the object in the sub-area, and
performing a plausibility check of the data of the external environmental sensor system depending on the first environmental information and the second environmental information, including depending on a comparison of the first features and the second features;
wherein the infrastructure system includes the external data source.

16. The infrastructure according to claim 15, wherein the environmental sensor system includes a stationary sensor system including at least one camera and/or one lidar sensor and/or one radar sensor.
